(19) United States
(12) Patent Application Publication
(10) Pub. No.: US 2025/0371890 A1
(43) Pub. Date: Dec. 4, 2025

(54) METHOD FOR CHARACTERIZING THE INTERNAL THREE-DIMENSIONAL ORGANIZATION OF A BIOLOGICAL SAMPLE

(71) Applicants: UNIVERSITE DE BORDEAUX, Bordeaux (FR); INSTITUT NATIONAL DE LA SANTE ET DE LA RECHERCHE MEDICALE, Paris (FR); CENTRE NATIONAL DE LA RECHERCHE SCIENTIFIQUE, Paris Cedex 16 (FR); INSTITUT POLYTECHNIQUE DE BORDEAUX, Talence Cedex (FR)

(72) Inventors: Christophe GROSSET, Pessac (FR); Baudouin DENIS DE SENNEVILLE, Talence (FR); Etienne GONTIER, Canejan (FR); Fatma-Zohra KHOUBAI, Bordeaux (FR); Alexandre LABEDADE, Vayres (FR)

(21) Appl. No.: 18/557,157

(22) PCT Filed: Apr. 25, 2022
(86) PCT No.: PCT/EP2022/060923

§ 371 Date: Jul. 18, 2025

(30) Foreign Application Priority Data
Apr. 27, 2021 (FR) FR2104357

(51) Int. Cl. G06V 20/69; G06T 7/00; G06V 10/82

(52) U.S. Cl. CPC G06V 20/698; G06T 7/0014; G06V 10/82; G06V 20/695; G06T 2207/20081; G06T 2207/20084; G06T 2207/30024

(57) ABSTRACT

One aspect of the invention concerns a method for characterizing the internal three-dimensional organization of a biological tissue sample comprising a plurality of types of biological elements (201, 202), said method having the following steps:
For at least one type of biological elements (201, 202, 203, 204) of interest among the plurality of types of biological elements (201, 202, 203, 204), automatic or semi-automatic segmentation in each image (I_{Z}) from a stack of images (I_{3D}), of at least one region containing at least one biological element (201, 202, 203, 204) having as type, the type of biological elements (201, 202,203, 204) of interest, the stack of images (I_{3D}) having been acquired by Z-series imaging by automated ultramicrotomy under scanning electron microscopy and including a plurality of images (I_{Z}) each acquired in a plane perpendicular to a depth axis (Z) and each associated with a position on the depth axis (Z), the plurality of images (I_{Z}) being ordered by increasing position in the stack of images (I_{3D}, 102);
Characterization of a set of biological elements (201, 202, 203, 204) having as type the type of biological elements (201, 202, 203, 204) of interest, by calculation, for each biological element (201, 202, 203, 204) from the set of biological elements (201, 202, 203, 204), of at least one indicator (301, 302) relating to the structure, the morphology, the size, the polarity, the texture, the constitution, the orientation, a surface area, the alignment, the convergence, the density, the convexity or the concavity of the biological element (201, 202, 203,204), from each corresponding segmented region (104);
Comparison between the indicators (301, 302) calculated for the set of biological elements (201, 202, 203, 204).

### TECHNICAL FIELD OF THE INVENTION

The technical field of the invention is the field of biological samples and more particularly the field of the study of the internal three-dimensional organization of biological samples.

The present invention relates to a method for characterizing a biological sample and more particularly to a method for characterizing the internal three-dimensional organization of a biological sample. The present invention further relates to the method for comparing the internal three-dimensional organization of a plurality of samples of biological tissue, and to a system, a computer program product and a recording medium for using the methods.

### TECHNOLOGICAL BACKGROUND OF THE INVENTION

A biological tissue, whether healthy or pathological, whether of human origin or not, includes many types of biological elements of microscopic or nanometric size. Such biological elements include organizational and structural elements such as blood capillaries and bile canaliculi, cells of tissue origin (muscle cells, hepatocytes, immune system cells, endothelial cells, nerve cells, red blood cells, circulating or infiltrating white blood cells including lymphocytes and macrophages, etc.) very varied in nature (normal cells, tumor cells, stromal cells, accessories, etc.), but also subcellular (or organelles) elements such as nuclei, nucleoli, mitochondria, cytoplasmic membranes, nuclear membranes, lipid vesicles, endoplasmic reticulum, exosomes, etc.

Nowadays, there are several electron microscopy techniques, including Z-series imaging by automated ultramicrotomy in scanning electron microscopy or SBF-SEM (serial block-face scanning electron microscopy), used for imaging the organization, architecture and the internal ultrastructure of a biological tissue at the nanoscale, over a large volume of up to 1000 picolitres.

The SBF-SEM technique consists in imaging the surface of a block of biological tissue sample by collecting backscattered electrons. The principle is to perform cycles of slices and image acquisitions of the surface of a sample. A first image of the sample surface is made by collecting the backscattered electrons, then the cutting system generates a first ultrafine cut of the sample in order to expose a lower layer of the sample to the electron beam. “Acquisition-Cut” cycles will then follow each other automatically, knowing that it is possible to acquire several hundred or even a few thousand successive images (including the axes X and Y) along the Z axis with a resolution of a few nm. Said technique also enables acquiring large-size images of the surface area of the sample (at the microscopic scale, a few tens to several hundreds of μm²) with a nanometric resolution (pixel size in XY from 1 to several tens of nm).

To be able to study the three-dimensional structure of a given biological element and thereby to be able to characterize same in order to quantify, study and evaluate the role thereof in a given biological phenomenon, it is then necessary to identify the element precisely on each of the images of the series of images acquired. Such identification is thus often performed manually by a specialist, which makes the task tedious and incompatible with the study of the complete internal organization of the sample that would require the identification of a large number of biological elements in each image.

There is thus a need for the method for obtaining, in a precise and reliable way and in a reasonable time, i.e. on the order of a few hours, a characterization of the internal three-dimensional organization of a biological sample.

### SUMMARY OF THE INVENTION

The invention provides a solution to the problems mentioned hereinabove, by making it possible to characterize precisely and reliably, the internal three-dimensional organization of a biological sample by minimizing the number of steps requiring the intervention of a specialist and by automating the procedure of analysis of the elements of a biological sample, of human, animal, plant or fungal origin, using mathematical procedures and artificial intelligence.

A first aspect of the invention relates to the method for characterizing the internal three-dimensional organization of a biological tissue sample comprising a plurality of types of biological elements, including the following steps:
For at least one type of biological element of interest among the plurality of types of biological elements, automatic or semi-automatic segmentation in each image from a stack of images, of at least one region containing at least one biological element having as type, the type of biological element of interest, the stack of images having been acquired by Z-series imaging by automated ultramicrotomy under scanning electron microscopy and including a plurality of images each acquired in a plane perpendicular to a depth axis and each associated with a position on the depth axis, the plurality of images being ordered by increasing position in the stack of images;
Characterization of at least one biological element having as type, the type of biological elements of interest, by calculation of at least one indicator relating to the structure, the morphology, the size, the polarity, the texture, the constitution or the orientation of the biological element from each corresponding segmented region.

By means of the invention, the complete or quasi-complete internal three-dimensional organization of a sample can be characterized since a characterization of each biological element of the sample can be obtained.

Since the segmentation of each biological element is obtained automatically or semi-automatically, the characterization of the three-dimensional organization of the sample is obtained much faster than in the prior art, the number of steps requiring human intervention, and more particularly the intervention of a specialist, being reduced by at least 90%.

Physical, geometrical, morphological, constitutional and organizational parameters are then extracted from the set of segmentations, in order to be directly correlated with biological concepts or to be compared with parameters obtained from other samples.

Thereby, e.g. in the field of oncology, the method according to the invention facilitates the investigation of all types of cancers or solid tumors derived from biopsies or tissue samples of patients, animals or various experimental models, e.g. spheroids, tumoroids, tumor organoids or xenografts of tumor cells in mice, chick embryos, Xenopus embryos, zebrafish or any other host animal model.

In addition to the features just mentioned in the preceding paragraph, the method according to the first aspect of the invention can have one or a plurality of supplementary features among the following, considered individually or in all technically possible combinations.

According to a variant of embodiment, the method according to the invention further comprises a step of three-dimensional reconstruction of at least one biological element having as type, the type of biological elements of interest, from each corresponding segmented region.

It is thereby possible to obtain a complete or almost complete reconstruction of the internal three-dimensional organization of the biological sample.

The method according to the invention can then eventually lead to the development of a three-dimensional imaging database accessible to researchers and clinicians, containing high-resolution three-dimensional images of biological tissues of various types and origins, as well as all the associated indicators, mathematical data and morphological parameters, either constitutional or organizational.

According to a variant of embodiment compatible with the preceding variant of embodiment, the method according to the invention further comprises a step of modification, alignment and optimization of the stack of images before the segmentation step.

Thereby, the modification step can consist of aligning the images along the depth axis, in order to facilitate the three-dimensional reconstruction, and/or of converting the images to a less heavy format, in order to consume less resources and to facilitate the segmentation, and/or of adjusting the brightness and the contrast of the images, and/or of removing noise in the images, in order to facilitate a subsequent segmentation.

According to a variant of embodiment compatible with the previous variants, the type of biological elements of interest is chosen from the following types: blood capillary, hemolysis zone, bile canaliculus, cell, cytoplasmic membrane, nucleus, nucleolus, nuclear membrane, mitochondrion, endoplasmic reticulum, lipid vesicle, exosome, vessel lumen, vacuole, peroxisome, cell wall, leukoplast, chloroplast or any other biological element composing the biological tissue or the cells.

According to a variant of embodiment compatible with the previous variants of embodiments, the segmentation step is carried out using an artificial neural network trained to be apt to detect in an image, each region comprising at least one biological element having as type, the type of biological elements of interest, the artificial neural network having been trained in a supervised manner on a training database comprising a plurality of images wherein each region containing at least one biological element of the type of biological elements of interest has been identified.

Thereby, the segmentation step is automatic, reliable and requires no human intervention. The accuracy/reliability rate obtained is e.g. greater than 90% for the segmentation of mitochondria and nuclei.

According to a sub-variant of the preceding variant of the embodiment, the segmentation step using the trained artificial neural network is followed by a visual check and a manual correction.

Thus, the segmentation step is semi-automatic and the corrected images can then be used for re-training the artificial neural network and thereby improve the precision and the reliability thereof.

According to a sub-variant of embodiment of the preceding variant of embodiment compatible with the preceding sub-variant of embodiment, the training database is supplemented with the images from the stack of images wherein each region containing at least one biological element having as type, the type of biological elements of interest has been segmented by the artificial neural network and the artificial neural network is re-trained on the completed training database.

Thereby, the more the artificial neural network is re-trained, the more the precision and the reliability thereof increase, which leads to reducing the number of visual check steps and manual corrections, and to further reducing the time required for the automatic segmentation step, while maintaining a high level of reliability.

According to a variant of embodiment compatible with the previous variants of embodiments except for the preceding variant of embodiment, the segmentation step is performed manually or semi-manually on a set of images from the stack of images and automatically using a propagation algorithm on each image from the stack of images between two images from the set of images from the stack of images.

Thereby, the segmentation step is semi-automatic and can be used for segmenting biological elements, e.g. cells, the contours of which are not always sharp on all the images from the stack of images.

According to a variant of embodiment compatible with the previous variants of embodiments, the indicator is chosen from the following indicators: volume, distance to another given biological element, surface area in a given plane, main axis, alignment with a given axis or plane, polarization towards a given point, length of short/long axes, texture indicator, perimeter of the outer envelope, fractal dimension of the surface, number of biological elements in contact, contact surface with neighboring biological elements, density of biological elements in a nearby region.

According to a variant of embodiment compatible with the previous variants of embodiments, the method according to the invention further comprises a step of comparison between the indicators calculated for a set of biological elements of the biological tissue sample.

Thereby, it is possible to study the links between the three-dimensional structures of different types of biological elements within the sample.

A second aspect of the invention relates to the method for comparing the internal three-dimensional organization of a plurality of samples of biological tissue comprising the steps of the method according to the first aspect of the invention for each biological tissue sample of a set of samples of biological tissue comprising a plurality of biological tissue samples, and a step of comparison between the indicators calculated for a set of biological elements of each biological tissue sample from the set of biological tissue samples.

Thereby, it is possible to study the links between the three-dimensional structures of several biological samples with the same tissue origin or with a different origin, including comparisons between tissues of different kingdoms (animal versus plant versus fungal, etc.), but also the links between the three-dimensional structures of a plurality of biological samples resulting from analyses performed at different times. Thereby, e.g. in the field of oncology, the method according to the second aspect of the invention makes it possible to study the potential links between the internal three-dimensional organization of a tumor tissue, the cellular and the subcellular content thereof, and the patients' response to treatment by comparing the parameters of the tissue before and after treatment, regardless of the treatment considered (chemotherapy, immunotherapy, surgery, radiotherapy, cryotherapy, electroporation, electrofocusing, thermotherapy, light therapy, etc.).

A third aspect of the invention relates to a system comprising a processor configured for implementing the steps of the method according to the first or second aspect of the invention.

A fourth aspect of the invention relates to a computer program product comprising instructions which, when the program is executed on a computer, lead the latter to implement the steps of the method according to the first or second aspect of the invention.

A fifth aspect of the invention relates to a computer-readable recording medium comprising instructions which, when executed by a computer, lead the latter to implement the steps of the method according to the first or second aspect of the invention.

The invention and the different applications thereof will be better understood upon reading the following description and examining the accompanying figures.

### BRIEF DESCRIPTION OF FIGURES

The figures are presented as indication and the invention is in no way limited to the figures.

FIG. 1 shows a block diagram illustrating the sequence of a method according to a first aspect of the invention.

FIG. 2 illustrates the result of segmentation, characterization and comparison steps of the method according to the first aspect of the invention by choosing cells and blood capillaries as types of biological elements of interest, and the main axis as indicator.

FIG. 3a shows a stack of images acquired by Z-series imaging by automated ultramicrotomy under scanning electron microscopy, ordered from left to right by increasing position along a depth axis Z, comprising a bile canaliculus.

FIG. 3b shows the result of a reconstruction step of the method according to the first aspect of the invention for the bile canaliculus, of the stack of images shown in FIG. 3a.

FIG. 4 illustrates an embodiment of a segmentation step of the method according to the first aspect of the invention using a propagation algorithm.

FIG. 5 shows the result of the reconstruction step of the method according to the first aspect of the invention, by choosing nuclei and blood capillaries as types of biological elements of interest.

FIG. 6 is a block diagram illustrating the sequence of steps of the method according to a second aspect of the invention.

### DETAILED DESCRIPTION

Unless otherwise specified, the same element appearing in different figures has one reference.

A first aspect of the invention relates to the method for characterizing the internal three-dimensional organization of a biological tissue sample.

“Three-dimensional organization of a sample” means the internal structure of the sample which can be detected using an electron microscope, i.e. in a range of values of about one to several hundred nanometers.

The biological tissue can be human, animal, plant or fungal.

The sample was taken e.g. by biopsy or surgical resection from a patient, an animal or any other relevant experimental model or from any biological, animal, plant or fungal source.

The sample has e.g. a volume on the order of 1 mm³.

A biological tissue includes a plurality of biological elements of different types.

A type of biological element is e.g. a cell, a red blood cell, a cytoplasmic membrane, a nucleus, a nucleolus, a nuclear membrane, a mitochondrion, a blood capillary, a lipid vesicle, a bile canaliculus, an endoplasmic reticulum, a hemolysis zone, the lumen of the vessels or further an exosome, a vacuole, a peroxisome, a cell wall, a leukoplast, a chloroplast. The type of cell analyzed can be of varied origin, such as plant, fungal, animal or human cardiac, muscular, endothelial, neuronal, immune, renal, pancreatic, pulmonary, hepatocyte, biliary, astrocytic, macrocytic, glial, intestinal, stomach cells.

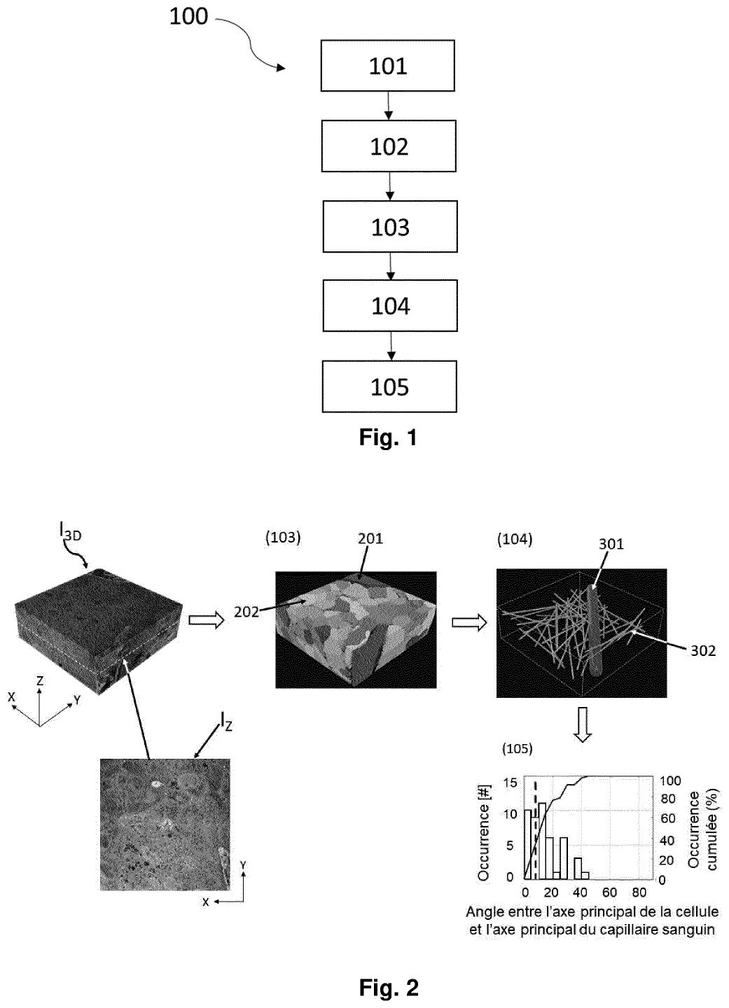

FIG. 1 is a block diagram illustrating the sequence of steps of the method 100 according to the first aspect of the invention.

The method 100 according to the invention is carried out on a stack of images of the biological tissue sample obtained by SBF-SEM.

Taking into account that the sample is placed in an orthogonal coordinate system (X, Y, Z) where Z corresponds to the depth of the sample, each image from the image stack is acquired along a plane comprising the axes X and Y and perpendicular to the depth axis Z.

The planes of the acquired images are parallel to each other and not coincident, i.e. the planes are spaced apart along the depth axis Z. Each plane can thus be associated with a position on the depth axis Z.

For example, if three images are acquired perpendicular to the depth axis Z in planes each spaced apart by 25 nm, the first image is e.g. associated with the 0 nm position on the depth axis Z, the second image at the 25 nm position on the depth axis Z, and the third image at the 50 nm position on the depth axis Z.

The images from the stack of images are ordered by increasing position along the depth axis Z.

FIG. 2 shows a stack of images I_{3D} acquired by SBF-SEM and an example of an image I_{Z} forming the stack of images I_{3D}.

The method 100 according to the invention can comprise a first step 101 of modification, alignment and optimization of the stack of images I_{3D}.

The first step 101 can consist in aligning the images I_{Z} from the stack of images I_{3D} along the depth axis Z and/or in converting the I_{Z} images from the stack of images I_{3D} into a less bulky format, e.g. from 32 bits to 8 bits, and/or in adjusting the brightness and the contrast of the images I_{Z} from the stack of images I_{3D}, and/or in removing the noise in the images I_{Z} from the stack of image I_{3D}, e.g. by applying a Gaussian filter.

A second step 102 of the method 100 according to the invention consists, for at least one type of biological elements of interest, in automatically or semi-automatically segmenting in each image I_{Z} from the stack of images I_{3D}, modified, if appropriate, during the first step 101, at least one region of the image I_{Z} containing at least one biological element having the type of biological elements of interest.

The type of biological elements of interest is chosen from among the types of biological elements classically present in the biological tissue forming the sample.

Thereby, if two types of biological elements of interest are chosen, e.g. the cells 202 and the blood capillaries 201, the second step 102 consists in segmenting each region comprising a cell 202 in each image I_{Z} from the stack of images I_{3D} and in segmenting each region comprising a blood capillary 201 in each image I_{Z} from the stack of images I_{3D}.

“Segmenting an element in an image” means identifying the contours of the element visible in the image.

The region of the segmented image I_{Z} can contain only the biological element, i.e. the contours of the region coincide with the contours of the biological element.

The region of the segmented image I_{Z} can also include within other biological elements in addition to the biological element of interest.

According to a first embodiment, the second step 102 is performed using an artificial neural network previously trained in a supervised way on a training database, in order to segment in each image I_{Z} from the stack of images I_{3D}, each region including at least one biological element of a given type.

An artificial neural network includes at least one artificial neural layer each including at least one artificial neuron. The artificial neurons of the artificial neural network are connected to each other by synapses and each synapse is assigned a synaptic coefficient.

Training or learning is used for training the artificial neural network to perform a predefined task, by updating the synaptic coefficients so as to minimize the error between the output data provided by the artificial neural network and the real output data, i.e. what the artificial neural network should output in order to fulfill the predefined task on a certain input datum.

A training database thus includes input data, each associated with a real output datum.

The training database thus includes images I_{Z} of samples of biological tissue acquired by SBF-SEM, as well as data on the contours of each region including at least one biological element of the given type present in each image I_{Z}.

The contour data for each region were obtained manually and/or automatically and/or by a combination of the two.

The artificial neural network is e.g. a convolutional artificial neural network, such as the U-Net network.

The second step 102 according to the first embodiment is then performed automatically.

The segmentation performed using the artificial neural network can be optionally followed by a visual check and a manual correction in order to check the quality of the output data provided by the artificial neural network. In such case, the second step 102 according to the first embodiment is performed semi-automatically.

Once the second step 102 is complete, the training database can be completed with images from the stack of images wherein each region containing at least one biological element of interest has been segmented, and the artificial neural network can be re-trained based on the completed training data.

According to a second embodiment, the second step 102 is carried out by manual or semi-manual segmentation of each region including at least one biological element of a given type in a set of images from the stack of images I_{3D} and by automatic segmentation of each region including at least one biological element of a given type in each image I_{Z} from the stack of images I_{3D} located between two images from the set of images in the stack of images I_{3D} using a propagation algorithm.

“Semi-manual segmentation of an element” means a segmentation performed manually on a portion of the element, the manually segmented portion of the element being used as input data for an algorithm then apt to fully segment the element automatically.

Such an algorithm is e.g. an artificial neural network or an image processing algorithm, e.g. a region-growing algorithm.

FIG. 4 illustrates the implementation of the second embodiment of the second step 102 on a plurality of images I_{Z} ordered by increasing position along the depth axis Z from the left to the right and from the top to the bottom, by choosing the cells 202 as the type of biological elements of interest.

On each image I′ from the set of images represented framed in dotted lines in FIG. 4, the contours of the cell 202 present in the image I′ were identified semi-manually and on each other image I_{Z}, i.e. on each image I_{Z} not belonging to the set of images I′, the contours of the cell 202 present in the image I_{Z} were identified automatically by the propagation algorithm from the contours of the cell 202 obtained for the image I′ from the set of images 130 immediately preceding the image Iz to be segmented.

In FIG. 4, the semi-manual segmentation is performed on one image I_{Z} out of 10, i.e. that the set of images I′ comprises one image I_{Z} out of 10 from the set of images I_{3D}.

The manual or semi-manual segmentation is performed e.g. using image annotation software.

The propagation algorithm is e.g. an algorithm based on the optical flow.

The second step 102 according to the second embodiment is then performed semi-automatically.

If a plurality of types of biological elements of interest is chosen, the second step 102 can be performed according to the first embodiment for certain types of biological elements of interest and according to the second embodiment for the other types of biological elements of interest.

Thereby, if two types of biological elements of interest are chosen, e.g. cells 202 and mitochondria, the second step 102 can be carried out according to the first embodiment for mitochondria and according to the second embodiment for the cells 202.

The method 100 according to the invention can include a third step 103 consisting in reconstructing the three-dimensional structure of each biological element included in a region segmented during the second step 102 from the segmentation of the region comprising the biological element in each image I_{Z} from the stack of images I_{3D}.

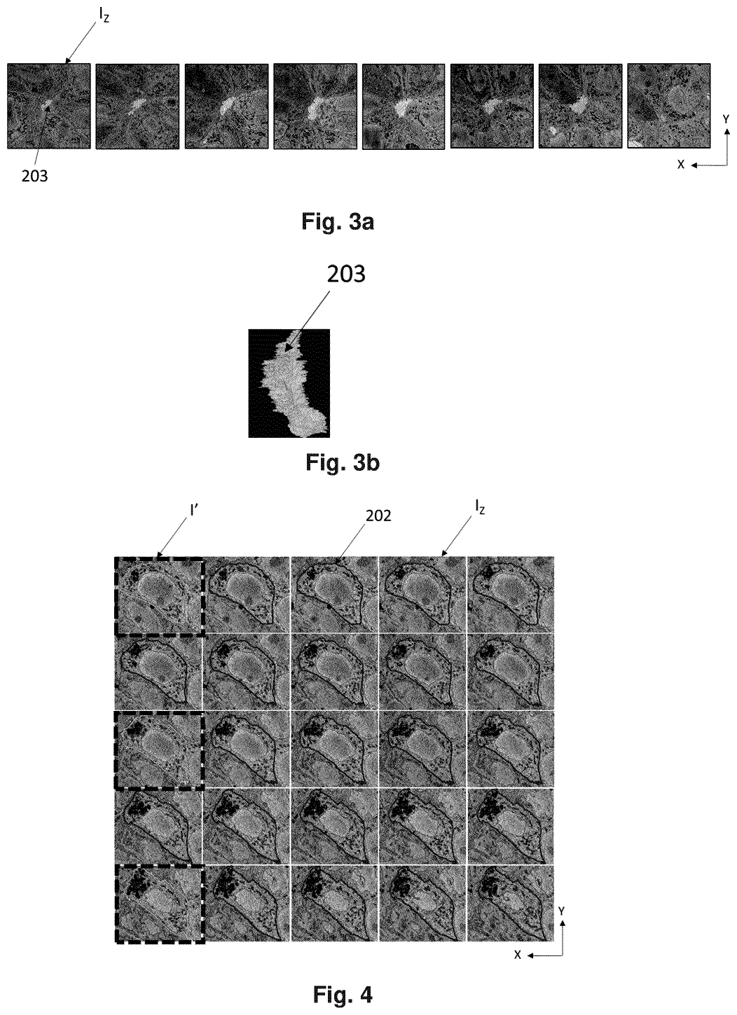

FIG. 3a shows a stack of images comprising eight images I_{Z} acquired by SBF-SEM and ordered from left to right by increasing position along the depth axis Z.

The first image I_{Z} corresponds to a 2.5 μm position along the depth axis Z, the second image I_{Z} corresponds to a 5 μm position along the depth axis Z, the third image I_{Z} corresponds to a 7.5 μm position along the depth axis Z, the fourth image I_{Z} corresponds to 10 μm position along the depth axis Z, the fifth image I_{Z} corresponds to a 12.5 μm position along the depth axis Z, the sixth image I_{Z} corresponds to a 15 μm position along the depth axis Z, the seventh image I_{Z} corresponds to a 17.5 μm position along the depth axis Z, and the eighth image I_{Z} corresponds to a 20 μm position along the depth axis Z.

In FIG. 3a, each image I_{Z} shows a section of the bile canaliculus 203.

FIG. 3b shows the three-dimensional reconstruction of the bile canaliculus 203 present in the images I_{Z} of FIG. 3a obtained from the segmentation of the bile canaliculus 203 in each image I_{Z} of FIG. 3a.

FIG. 2 shows the three-dimensional reconstruction of the cells 202 and of the blood capillaries 201 of a sample obtained from a stack of images I_{3D} acquired by SBF-SEM.

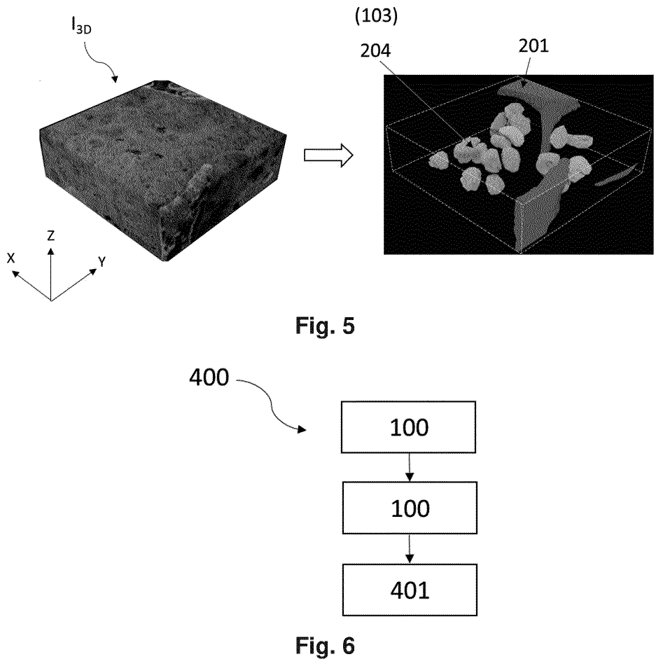

FIG. 5 shows the three-dimensional reconstruction of the nuclei 204 and of the blood capillaries 201 of a sample, obtained from a stack of images I_{3D} acquired by SBF-SEM.

A fourth step 104 of the method 100 consists in characterizing at least one biological element of a type of biological elements of interest by calculating at least one indicator from each region segmented for the biological element in the stack of images I_{3D}.

An indicator can be related to the structure, the morphology, the size, the polarity, the texture, the constitution, the orientation, to a surface area, to the alignment, the convergence, the density, the convexity or the concavity of the biological element.

The indicator is e.g. the volume of the biological element, the distance between the biological element and another given biological element of the sample, the surface area of the biological element in a given plane, the main axis of the biological element, the alignment of the biological element with a given axis or plane, the polarization of the biological element towards a given point, the length of the short/long axes of the biological element, an indicator of the texture of the biological element, e.g. the co-occurrence matrix, the perimeter of the outer envelope of the biological element, the fractal dimension of the surface of the biological element, the number of biological elements in the sample in contact with the biological element, the contact surface between the biological element and neighboring biological elements in the sample, the density of biological elements in the region wherein the biological element is located or in a neighboring region.

The indicator can e.g. be the orientation of the nucleus-mitochondrion axis, the number of cells in contact with a cell of interest, or further the contact surface of a cell of interest with neighboring cells.

FIG. 2 represents by a rod, the main axis 302 of each cell 202 and by a cylindrical shape, the main axis 301 of the single blood capillary 201 obtained from the three-dimensional reconstruction of each cell 202 and of the blood capillary 201.

The main axis 301, 302 of a biological element is obtained e.g. by principal component analysis on the coordinates of the voxels forming the three-dimensional reconstruction of the biological element.

The method 100 according to the invention can include a fifth step 105 consisting in comparing with each other, the indicators calculated in the fourth step 104 for a given set of biological elements, i.e. to compare the indicators calculated in the fourth step 104 for each biological element from the set of biological elements.

The set of biological elements includes a plurality of biological elements each of which is of a type of biological elements of interest. When the second step 102 was performed for a plurality of types of biological elements of interest, the set of biological elements can thus include different types of biological elements.

FIG. 2 includes a histogram representing, for different angle values between the main axis 301 of the blood capillary 201 and the main axis 302 of the cell 202, the number of cells 202 having a main axis 302 separated by the angle value from the main axis 301 of the blood capillary 201.

The histogram further includes the cumulative number of cells for each angle value.

It is then possible to deduce therefrom that more than three quarters of the cells 202 of the sample are oriented with an angle of inclination of 0 to 20° with respect to the blood capillary 201, and thus that the blood capillary 201, which has an angle of inclination of 8°, can have a role in the orientation of the cells 202.

A second aspect of the invention relates to the method for comparing the internal three-dimensional organization of a plurality of samples of biological tissue.

FIG. 6 is a block diagram illustrating the sequence of steps of the method 400 according to the second aspect of the invention.

The method 400 according to the invention includes the steps of the method 100 according to the first aspect of the invention for each biological tissue sample of a set of samples of biological tissue.

The set of samples of biological tissue comprises a plurality of samples of the same biological tissue or of different biological tissues.

In FIG. 6, the set of samples of biological tissue includes two samples and the steps of the method 100 according to the first aspect of the invention are thus carried out twice.

The method 400 according to the invention further includes a step 401 of comparison between the indicators calculated for a set of biological elements of each biological tissue sample from the set of samples of biological tissue.

1. A method for characterizing the internal three-dimensional organization of a biological tissue sample comprising a plurality of types of biological elements, including the steps of:
for at least one type of biological elements of interest among the plurality of types of biological elements, automatic or semi-automatic segmentation in each image from a stack of images, of at least one region containing at least one biological element having as type, the type of biological elements of interest, the stack of images having been acquired by Z-series imaging by automated ultramicrotomy under scanning electron microscopy and including a plurality of images each acquired in a plane perpendicular to a depth axis and each associated with a position on the depth axis, the plurality of images being ordered by increasing position in the stack of images;
characterization of a set of biological elements having as type, the type of biological elements of interest, by calculation, for each biological element from the set of biological elements, of at least one indicator relating to the structure, the morphology, the size, the polarity, the texture, the constitution, the orientation, a surface area, the alignment, the convergence, the density, the convexity or the concavity of the biological element, from each corresponding segmented region (104);
comparison between the indicators calculated for the set of biological elements.

2. The method according to claim 1, further comprising a step of three-dimensional reconstruction of at least one biological element having as type the type of biological elements of interest, from each corresponding segmented region.

3. The method according to claim 1, further comprising a prior step of modifying, aligning and optimizing the stack of images.

4. The method according to claim 1, wherein the type of biological elements of interest is chosen from the following types: cell, cytoplasmic membrane, nucleus, nucleolus, nuclear membrane, mitochondrion, blood capillary, lipid vesicle, bile canaliculus, endoplasmic reticulum, exosome, vessel lumen, hemolysis zone, vacuole, peroxisome, cell wall, leukoplast, and chloroplast.

5. The method according to claim 1, wherein the segmentation step is performed using an artificial neural network trained to be apt to detect in an image, each region containing at least one biological element having as type, the type of biological elements of interest, the artificial neural network having been trained in a supervised way on a training database comprising a plurality of images wherein each region containing at least one biological element having as type, the type of biological elements of interest was identified.

6. The method according to claim 5, wherein the step of segmentation using the trained artificial neural network is followed by a visual check and a manual correction.

7. The method according to claim 5, according to which the training database is completed with the images from the stack of images wherein each region containing at least one biological element having as type, the type of biological elements of interest has been segmented by the artificial neural network and the artificial neural network is re-trained on the completed training database.

8. The method according to claim 1, wherein the segmentation step is performed manually or semi-manually on a set of images from the stack of images and automatically using a propagation algorithm on each image from the stack of images located between two images from the set of images in the stack of images.

9. The method according to claim 1, wherein the indicator (301, 302) is chosen from the following indicators: volume, distance to another given biological element, surface area in a given plane, main axis, alignment with a given axis or plane, polarization to a given point, length of the short axes/long axes, texture indicator, perimeter of the outer envelope, fractal dimension of the surface, number of biological elements in contact, surface of contact with neighboring biological elements, density of biological elements in a nearby area.

10. A method for comparing the internal three-dimensional organization of a plurality of samples of biological tissue comprising the steps of the method according to claim 1 for each sample of biological tissue of a set of samples of biological tissue comprising a plurality of samples of biological tissue, and a step of comparison between the indicators calculated for a set of biological elements of each sample of biological tissue from the set of samples of biological tissue.

11. A system comprising a processor configured for implementing the steps of the method according to claim 1.

12. A computer program product comprising instructions which, when the program is executed on a computer, lead the computer to perform the steps of the method according to claim 1.

13. A computer-readable recording medium comprising instructions which, when executed by a computer, lead the computer to perform the steps of the method according to claim 1.
